(19) United States
(12) Patent Application Publication
(10) Pub. No.: US 2015/0268458 A1
(43) Pub. Date: Sep. 24, 2015

(54) METHOD FOR FLUORESCENCE MICROSCOPY OF A SAMPLE

(71) Applicant: Carl Zeiss Microscopy GmbH, Jena (DE)

(72) Inventors: Peter SCHOEN, Goettingen (DE); Thorsten KUES, Bovenden-Eddigehausen (DE); Sebastian RHODE, Muenchen (DE)

(21) Appl. No.: 14/660,829

(22) Filed: Mar. 17, 2015

(30) Foreign Application Priority Data
Mar. 18, 2014 (DE) 102014204994.6

(51) Int. Cl. G02B 21/00; G02B 21/06

(52) U.S. Cl. CPC G02B 21/0076; G02B 21/06

(57) ABSTRACT

A method for fluorescence microscopy of a sample. The method includes illuminating the sample with excitation radiation of a microscope through an illumination beam path and imaging along an optical axis to an image field on a camera chip, the illumination beam path having an adjustable diaphragm for selective illumination of a target area; selecting an area on the sample as a target area; and adjusting an adjustable diaphragm for selective illumination of the target area such that parts of the sample lying outside of the selected area are not illuminated with excitation radiation.

### PRIORITY CLAIM

The present application claims priority to German Patent Application No. 102014204994.6 filed on Mar. 18, 2014, which said application is incorporated by reference in its entirety herein.

### FIELD OF THE INVENTION

The invention relates to a method for fluorescence microscopy of a sample, in which a microscope is used which illuminates the sample with excitation radiation through an illumination beam path and images the sample along an optical axis on a camera chip, wherein the illumination beam path has an adjustable diaphragm for selective illumination of a target area, an area on the sample is selected as target area and the adjustable diaphragm for selective illumination of the target area is set such that parts of the sample lying outside of the selected area are not illuminated with excitation radiation.

### BACKGROUND OF THE INVENTION

Microscopy plays an important part in biomedical sciences. Biological samples may be present on the most varied sample carriers, e.g., between specimen slide and cover glass, in Petri dishes or Microtiter plates. They may still be alive or be fixed, uncolored or colored. Frequently, these samples are examined by means of fluorescence microscopy. Added fluorophores make it possible to stain specific cell components in targeted manner. For imaging, the fluorescent dyes are excited with light of a suitable wavelength, which usually takes place by reflected light illumination in which the illuminating light is focussed through the objective onto the observed sample area. The fluorescence signal—red-shifted vis-à-vis the excitation light—is received by the same objective, separated from the excitation light by means of a dichroite and suitable filters and conducted to a camera or an eyepiece. Unstained samples can also be examined by means of fluorescence microscopy if they contain auto-fluorescing constituents as fluorophores.

Often, fluorescence signals are very weak, which is why high excitation light intensities are used. However, high intensities in turn lead to heightened photobleaching. This term encompasses different processes which lead to fluorophores no longer emitting any light. This can refer both to reversible processes in which the fluorophor is switched off only for a specific period of time after interaction with light and also irreversible processes which destroy the fluorophor. By reducing the excitation light intensity, the extent of the photobleaching can be reduced, but at the same time, generally, the signal intensity is also reduced as a result. This can be compensated for by extending the camera recording time or else a poorer signal-to-noise ratio must be accepted. This route is therefore often not possible due to the weakness of the fluorescence signals.

Another possibility for reducing photobleaching is illuminating the sample only at times when the camera is recording. The light source is then switched on only while a camera is recording and then switched off again immediately afterwards. This synchronization of the illumination and recording can be triggered by software or hardware. Alternatively, a shutter can be inserted into the illuniination beam path, which shutter blocks the beam path and unblocks it only while the camera is recording.

Furthermore, so-called illumination field diaphragms are known in microscopes which have exchangeable camera chips. An example of such a microscope is the AxioScan.Z1 from Carl Zeiss. In cameras of different chip sizes, this diaphragm serves to match the illuminated area to the dimension of the camera chip for each camera, and not illuminate the rest of the object field. As the camera chips are centered on the optical axis, the aperture size of such illumination field diaphragms can be set about a fixed aperture center, which is likewise centered on the optical axis.

In conjunction with a specific type of fluorescence microscopy, U.S. Pat. No. 8,089,691 B1 outlines adjustable diaphragm devices with which the illuminated area in the sample can be selected freely. Both the outline and also the position of the illuminated area is set. The microscope mentioned in the US document serves for FRAP microscopy in which a target area in the sample is intended to be photobleached selectively.

A method is described in U.S. Pat. No. 6,944,326 B1 in which a person can click on a pixel in the camera image, the coordinates of which pixel are noted by software. If, then, a change to an objective with a different zoom is made, the table thus operates such that the clicked-on pixel is located again at the same point of the camera image. Moreover, the microscope is equipped with a motorized illumination field diaphragm in the transmitted light beam path.

A sliding scanner which works in transmitted light is described in US 2005/0254696 A1. After a change in objective, a transmitted light illumination field diaphragm can be set to the corresponding objective within the framework of a Köhler illumination.

A microscope which has a motorized illumination field diaphragm in transmitted light is described in US 2002/0060842 A1. The size of this diaphragm can be changed by the user.

The illumination field diaphragm is used as the camera chip is generally smaller than the maximum transmissible image field is in the camera-chip plane. This property is also very useful, as otherwise, parts of the camera chip can never be used for recording samples. As camera chips are rectangular, this rectangle lies within the circle of the image field which is determined by the imaging of the object field transmitted by the beam path. Illumination field diaphragms are equally as useful for incident light illumination and for transmitted light beam paths.

### SUMMARY OF THE INVENTION

An object of the invention is to provide a method for fluorescence microscopy of a sample in which undesired photobleaching is avoided.

The invention achieves this object with a method for fluorescence microscopy of a sample, in which
a microscope is used which illuminates the sample with excitation radiation through an illumination beam path and images the sample along an optical axis to an image field on an exchangeable camera chip, wherein the illumination beam path has an adjustable diaphragm for selective illumination of a target area,
location and size of the target area on the sample is selected within the image field and
the adjustable diaphragm for selective illumination of the target area is set such that parts of the sample lying outside of the selected area are not illuminated with excitation radiation, wherein
the microscope used has an illumination field diaphragm in the illumination beam path, which illumination field diaphragm has an adjustable aperture size and a fixed aperture center to match a field illuminated on the sample to the size of the exchangeable camera chip,
the illumination field diaphragm is used as the adjustable diaphragm for selective illumination of the target area by relatively displacing the sample and optical axis to have the selected area cover the aperture center and by setting the aperture size of the illumination field diaphragm to illuminate the selected area and to not illuminate parts of the sample lying outside of the selected area but still within the image field.

In known microscopes, the invention utilizes the illumination field diaphragm with a surprising benefit. By suitably setting the illumination field diaphragm and by displacing the sample relative to the optical axis such that the target area lies at the aperture center of the illumination field diaphragm, ideally centered thereupon, and by adjusting the aperture size of the illumination field diaphragm, any undesired photobleaching of areas which lie outside of the area selected as target area can be avoided. Where the state of the art required a further costly structure in order to mask a freely selectable target area, the inventive method now utilizes an illumination field diaphragm already in place for other reasons. Such illumination field diaphragms are in place in particular in microscopes with an exchangeable camera chip—either because the microscope has changeable chips or because different cameras can be attached to record images.

It is an aspect of the invention that the sample is relatively displaced transverse to the optical axis such that the selected area covers the aperture center of the illumination field diaphragm. Displacement transverse to the optical axis can be done by moving a sample table. It is equally possible, analogously, to move the objective perpendicular to the optical axis. This, too, is a relative displacement of sample and optical axis.

In a method according to an embodiment, a microscope is utilized, the illumination field diaphragm of which is a rectangular diaphragm which can be adjusted in terms of width and height. Such rectangular diaphragms are customary for rectangular camera chips. Equally, it is possible that the illumination field diaphragm is an iris diaphragm which can be adjusted in terms of diameter.

The aperture size of the illumination field diaphragm is set such that it masks the area selected as target area in the image field. By this is meant that the selected area is illuminated with excitation radiation and portions of the image field lying outside of the selected area of the sample are shaded. Depending on the outline of the selected area, parts of the sample occasionally directly adjoining do of course still lie within the masked area. Nevertheless, it is ensured that substantial areas of the sample are protected against excitation radiation and thus against photobleaching. In some embodiments, the relative displacement of the sample places the center of the greatest extension of the sample directly onto the aperture center as then the target area is almost fully constituted by the area of the image field masked by the illumination field diaphragm. In other words, the proportion of sample components of the image field which lie within the masked area of the illumination field diaphragm and are not part of the actual target area is then minimized. In such an alignment of the relative position of the sample, the aperture size of the illumination field diaphragm can be minimized.

Depending on the microscope utilized it may be the case that the illumination field diaphragm is located within a plane which is not exactly conjugated to the camera chip plane. In this case, edges of the illumination field diaphragm are not displayed sharply in the camera chip plane, but with a certain defocus. In order not to produce any uncertainty at the edge, it is preferred, when limiting the selected area, to arrange for the illumination field diaphragm to be somewhat larger. A buffer zone of 0.3 to 0.8 mm width in the camera chip plane is advantageous. It is therefore preferable that the selected area is extended by a buffer zone of the named width before the aperture size of the illumination field diaphragm is set.

The method for applying fluorescence microscopy is, self-evidently, particularly advantageous in an automated microscopy and in particular in an automatic setting of the illumination field diaphragm. It is therefore preferred that a microscope is used, the illumination field diaphragm of which can be adjusted by motor and which has a control device which displays a preview image of the sample to a user, offers the possibility of selection for the target area and carries out sample relative displacement and illumination field diaphragm adjustment automatically.

It is understood that the features mentioned above and those yet to be explained in the following are applicable, not only in the stated combinations, but also in other combinations or singly, without departure from the scope of the present invention.

### BRIEF DESCRIPTION OF THE FIGURES

The invention is explained by way of example in yet greater detail in the following with reference to the attached drawings, which also disclose features essential to the invention, in which:

FIG. 1 is a schematic representation of a microscope for applying fluorescence microscopy;

FIG. 2 is a top view over a camera chip of the microscope of FIG. 1; and

FIG. 3 is a flow diagram of the sequence of a method for applying fluorescence microscopy, wherein setting positions of a illumination field diaphragm of the microscope of FIG. 1 are input for individual steps by way of example.

### DETAILED DESCRIPTION

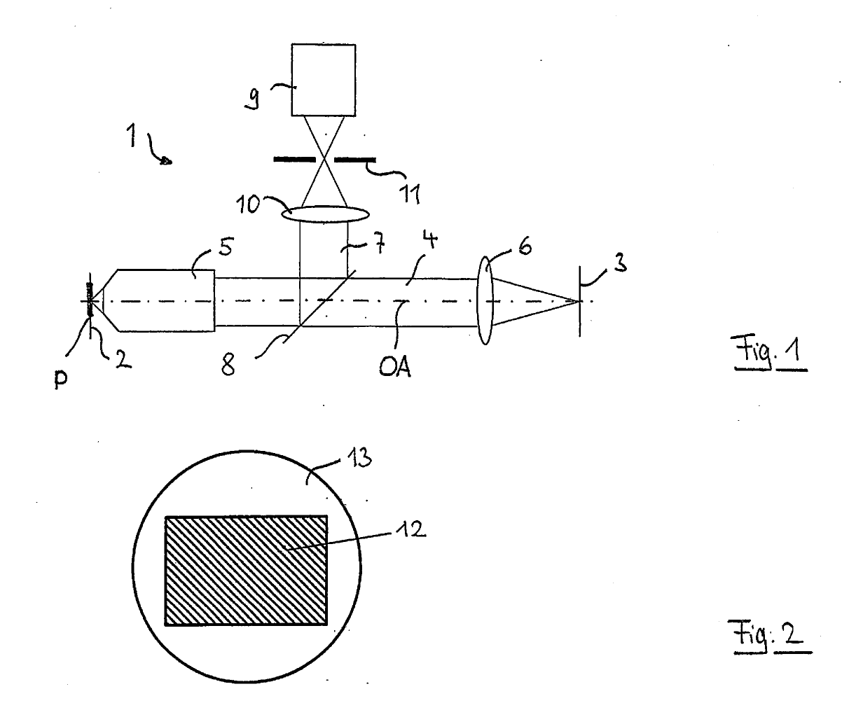

FIG. 1 shows schematically a microscope 1 for applying fluorescence microscopy to a sample P located in a sample plane 2. This sample P is imaged along an optical axis OA to a camera chip plane 3 in which a camera chip of a microscope camera is located. The microscope 1 is designed to have an exchangeable microscope camera, i.e., different camera chips, in particular with different dimensions and/or aspect ratios, which can be arranged in the camera chip plane 3.

The sample P is projected to the sample plane 2 along the optical axis OA by an imaging beam path 4 which comprises in particular an objective 5 and a tube lens 6. An illumination beam path 7 for incident light illumination of the sample P via a beam splitter 8 is reflected into the imaging beam path 4. Light from a light source 9 is directed onto the sample P through the imaging beam path 4. Thus the imaging beam path 4 and the illumination beam path 7 run parallel between the beam splitter 8 and the sample plane 2.

The imaging beam path comprises a tube lens 10 and an illumination field diaphragm 11 with which the illuminated field in sample P can be set. The microscope 1 is of customary design and can, for example, be provided in the form of the microscope AxioScan.Z1 from Carl Zeiss.

The microscope 1 shown in FIG. 1 is an incident light microscope. However, unless explicitly stated otherwise, the following explanations also apply to a transmitted light microscopy. In such case, the beam splitter 8 would be dispensed with in respect of the microscope of FIG. 1 and the illumination beam path 7 would irradiate the excitation radiation for applying fluorescence microscopy along optical axis OA from the side of sample plane 2 opposite objective 5.

The light source 9 is designed for fluorescence microscopy of the sample P in the microscopy method described here. The radiation guided in the illumination beam path 7 is thus excitation radiation, and the illumination beam path 7 is designed to illuminate the sample with excitation radiation.

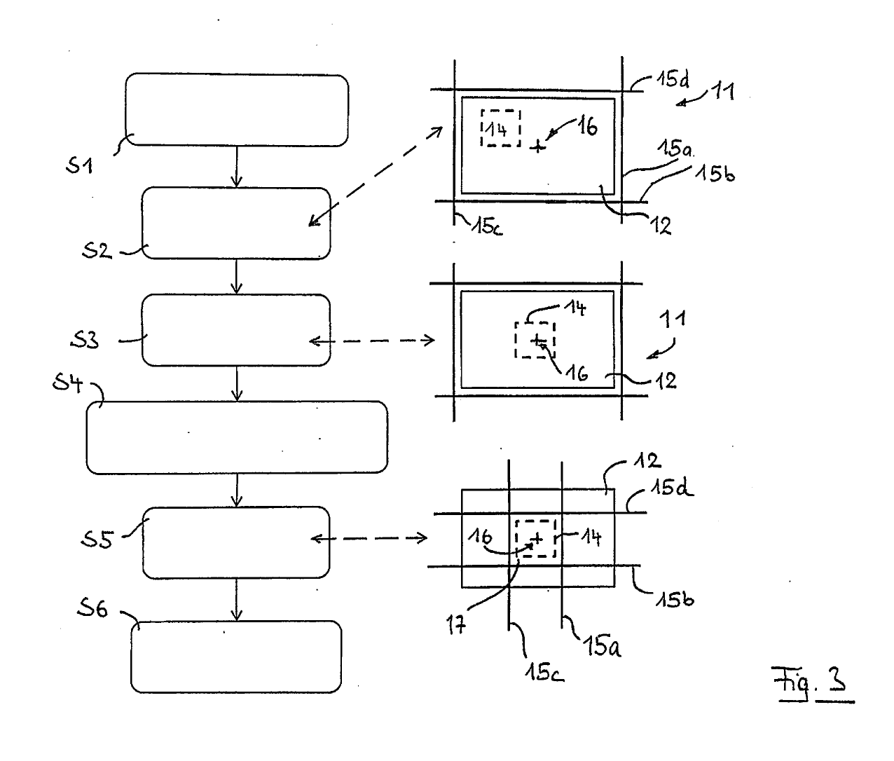

FIG. 2 shows a camera chip 12 as used in the microscope of FIG. 1 in a top view along the optical axis OA onto camera chip plane 3. The camera chip 12 is rectangular. The image field 13 provided by the imaging beam path 4 is larger than the camera chip 12, as already explained in the general part of the description. The illumination field diaphragm 11 serves to match the part of the image field 13 illuminated by the microscope to the camera chip 12. In the simplest case, the diaphragm 11 is designed as a rectangular diaphragm, the opposing edges of which are adjusted synchronous and in opposite directions, with the result that the aperture size of the illumination field diaphragm 11 can be matched to the size of the camera chip 12. The illumination field diaphragm 11 can thus be set to any rectangular form, but the aperture center of the diaphragm always remains at the same point.

An area in the sample P is selected as a target area in the image field 13, on which fluorescence microscopy is intended to be carried out. This area will, of course, generally not lie centered on the optical axis. In order, however, to prevent fluorescence bleaching of parts of the sample lying within the image field 13 but outside of the selected area, the method shown schematically in FIG. 3 is carried out.

In a step S1, an image of the sample P is recorded. Then, in a step S2, a target area 14 is defined in the image field 13. The representation of the top view on the illumination field diaphragm 11 with the camera chip 12, denoted by the two-headed arrow, shows the relationships in the image field 13 and thus in the sample plane 2. As the camera chip plane 3 is conjugated to the sample plane 2, the camera chip 12 is also schematically drawn in the topmost schematic representation on the right-hand side of FIG. 3. The optical axis OA runs through the aperture center 16 and is perpendicular to the drawing plane in the schematic representation relating to step S2.

In FIG. 2, a selected area 14 is selected as the target area for fluorescence microscopy in the image field 13. As already mentioned, it usually lies decentralized to the aperture center 16 of the illumination field diaphragm 11 which is formed by diaphragm edges 15a-15d. The opposing edges 15a/15c and 15b/15d are adjusted synchronously and in opposite directions, with the result that the aperture size of the illumination field diaphragm 11 can be set about the aperture center 16. Simply setting the illumination field diaphragm 11 would, however, irradiate illumination to large areas of the image field 13 which lie outside of the selected area 14.

In step S3, therefore, a relative displacement of the sample P and the optical axis OA is undertaken in embodiments by adjusting a sample table. The relative displacement is done such that the selected area 14 covers the aperture center 16, or is ideally centered around this. This state is shown in the schematic representation allocated to step S3.

Now, in step S4, a calculation is carried out calculating from the edges of the selected area 14 a minimum aperture size of the illumination field diaphragm 11. Then, in step S5, the aperture size of the illumination field diaphragm 11 is set accordingly, by moving the edges 15a and 15c, which define the illumination field diaphragm 11, towards one another, and doing the same for edges 15b and 15d. Because, as already mentioned at the outset, the imaging of the edges 15a-15d, and thus the masking by means of the illumination field diaphragm 11, can be affected by defocus, some embodiments establish a buffer zone 17 of 0.3 to 0.8 mm in width (measured in the camera chip plane 3) about the selected area 14 in order to guarantee a uniform illumination of the selected area 14 with excitation radiation.

Then, in step S6, an image of the selected area 14 is recorded in which, on the basis of the setting of the illumination field diaphragm 11 and the adjustment of the sample P relative to the optical axis OA (and thus to the aperture center 16) in the image field 13, essentially only the selected area 14 is illuminated as a target area and parts of the image field 13 lying outside thereof are protected against excitation radiation.

The sequence of steps S3 and S4 can be varied. Whether firstly the sample is relatively displaced (step S3) and then the illumination field diaphragm is matched (step S4) or vice versa does not matter. Both can also be provided in parallel.

The target area in the image field 13 can also be defined without prior imaging of the sample P if the position of the target area in the image field 13 is otherwise known. This can be the case, e.g., from reference markings for the location of the sample P. As a result, step Si is optional, and step S2 needs not necessarily use a sample image to define the selected area 14 as a target area.

Thus far, only rectangular illumination field diaphragms have been taken into consideration. However, the invention can also be used in the same manner with other illumination field diaphragms, e.g., with iris diaphragms as are frequently found in ocular-based microscopes. Iris diaphragms provide only circular or approximately circular light fields. Their advantage lies in the fact that the size of the field can be controlled with only one motor. If an iris diaphragm is used, the diaphragm can also be matched to a rectangular target area such that the illumination field diaphragm describes a circumference of this rectangle.

All embodiment examples described thus far have the motorized illumination field diaphragm in the incident light beam path. Self-evidently, embodiments are also possible with the illumination field diaphragm in a transmitted light beam path. The point of an illumination field diaphragm in the transmitted light beam path is, however, mainly to match the laminating field to the object fields which can be very different for different objective magnifications.

Transmitted light radiation is also substantially less critical regarding bleaching of fluorophores. However, it can be advantageous, in particular with very sensitive fluorophores, to minimize the light levels at locations of the sample field not relevant to current observation. This is done by making the transmitted light illumination field diaphragm smaller. Additionally, a smaller illumination field can considerably simplify focussing: Many samples are contrast-weak in transmitted light, which places heavy demands on autofocus. If, by contrast, the illumination field diaphragm is made smaller, with the result that its edges can be seen in the image, these edges can be used for focussing, as they provide a very strong contrast signal.

The described embodiments are advantageous in particular for the following microscopy applications:

1. In an overview image, individual cells are intended to be detected using the fluorescence signal, then segmented and observed over a period of time. The surrounding cells, which also have a fluorescence staining, shall not be illuminated in this time if possible, to avoid premature bleaching. The illumination field diaphragm 11 can be used to reduce the phototoxicity in parts of the sample P not relevant at this moment.

2. Using software autofocus. For this purpose, for reasons of speed, an image area on the chip is usually defined which is relevant to the evaluation of the image. While SW-AF is in progress, it is not sensible to illuminate parts of the sample outside of this target area. For the AF function, therefore, the use of an illumination field diaphragm to reduce the illuminated field of the AF region is advantageous.

3. In an image, only one cell or a specific area is intended to be excited by photoactivation with light. The surrounding cells or areas are, however, intended to remain outside of activation. In order to limit the activated area, the illumination field diaphragm 11 can be used.

1. A method for fluorescence microscopy of a sample, comprising
illuminating the sample with excitation radiation of a microscope through an illumination beam path and imaging the sample along an optical axis to an image field on a camera chip, wherein the illumination beam path has an illumination field diaphragm in the illumination beam path, the illumination field diaphragm having an adjustable aperture size and a fixed aperture center and being provided to match a field illuminated on the sample to a size of the camera chip;
selecting an area on the sample as a target area within the image field; and
adjusting the illumination field diaphragm for selective illumination of the target area by relatively displacing the sample against an optical axis to have the selected area cover the aperture center and by setting an aperture size of the illumination field diaphragm to illuminate the selected area and to not illuminate parts of the sample lying outside of the selected area but still within the image field.

2. The method according to claim 1, wherein the microscope comprises the illumination field diaphragm in a form of a rectangular diaphragm which can be adjusted in terms of width and height or in a form of an iris diaphragm which can be adjusted in terms of diameter.

3. The method according to claim 1, wherein a greatest extent of the selected area is determined and the sample is relatively displaced such that the center of the greatest extent lies on the aperture center.

4. The method according to claim 1, wherein the selected area is extended by a buffer zone of 0.3 to 0.8 mm in width to form an extended selected area, before the aperture size of the illumination field diaphragm is set to cover the extended selected area.

5. The method according to claim 1, wherein the microscope comprises an illumination field diaphragm which can be adjusted by motor, and a control device adapted to display a preview image of the sample to a user, to enable selection of the target area and to carry out sample displacement and illumination field diaphragm adjustment automatically.
